(19) United States
(12) Patent Application Publication
(10) Pub. No.: US 2006/0021477 A1
(43) Pub. Date: Feb. 2, 2006

(54) Comfortable driving spanner

(76) Inventor: Shih-Kuei Hsien, Taichung Hsien (TW)

Correspondence Address: Shih-Kuei Hsien, 235 Chung - Ho, Box 8-24, Taipei, TW

(21) Appl. No.: 10/902,411

(22) Filed: Jul. 30, 2004

(51) Int. Cl. B25B 23/16; B25G 1/00

(52) U.S. Cl. 81/177.8; 81/177.1

(57) ABSTRACT

A comfortable driving spanner has a holding portion; an engaging portion; and a pivotal portion for connecting the holding portion and the engaging portion thereby, the engaging portion being rotatable with respect to the holding portion for engaging with and driving a screw element. The holding portion has two bottoms and two lateral surfaces; areas of the bottoms are reduced from the connecting groove to a normal area with a predetermined width; in the normal area, the ration of the width of the bottoms to the width of the lateral surfaces is between 2/5 to 2/9.

### FIELD OF THE INVENTION

The present invention relates to spanners, and particular to a comfortable driving spanner, wherein the design of the comfortable driving spanner matches the requirement of ergonomics so that the user can hold the spanner comfortably and easily.

### BACKGROUND OF THE INVENTION

In the prior art, a spanner includes an engaging portion and a holding portion. In general, the engaging portion and the holding portion are placed at the same plane. In use, a force is applied from a slender side of the holding portion. If the user operates the spanner for a long time, he (or she) will get possibly carpal tunnel syndrome or other hand related disease. To improve the above said defect, in one improvement, the holding portion is thickened and has a streamline shape. However, this causes that the cost is increase and the machining work in manufacturing process becomes complicated so that the yield ratio is decreased. Furthermore, since the spanner becomes heavy, it is inconvenient in carry.

### SUMMARY OF THE INVENTION

Accordingly, the primary object of the present invention is to provide a comfortable driving spanner has a holding portion; an engaging portion; and a pivotal portion for connecting the holding portion and the engaging portion thereby, the engaging portion being rotatable with respect to the holding portion for engaging with and drives a screw element. The holding portion has two bottoms and two lateral surfaces. Areas of the bottoms are reduced from the connecting groove to a normal area with a predetermined width. In the normal area, the ratio of the width of the bottoms to the width of the lateral surfaces is between 2/5 to 2/9.

The various objects and advantages of the present invention will be more readily understood from the following detailed description when read in conjunction with the appended drawing.

### BRIEF DESCRIPTION OF THE DRAWINGS

FIG. 1 is an exploded schematic view of the comfortable driving spanner of the present invention.

FIG. 2 is a schematic perspective view of the comfortable driving spanner of the present invention.

FIG. 3 is a schematic view of the comfortable driving spanner of the present invention.

FIG. 4 is a schematic perspective view of the second embodiment of the present invention.

FIG. 5 is a schematic cross view of the third embodiment of the present invention.

FIG. 6 is a schematic cross view of the fourth embodiment of the present invention.

FIG. 7 is a schematic cross view of the fifth embodiment of the present invention.

FIG. 8 is a schematic cross view of the sixth embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

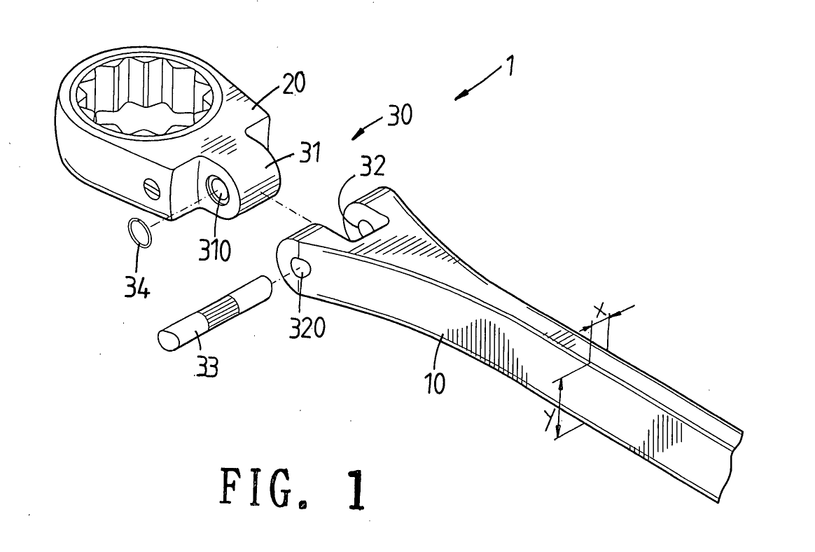

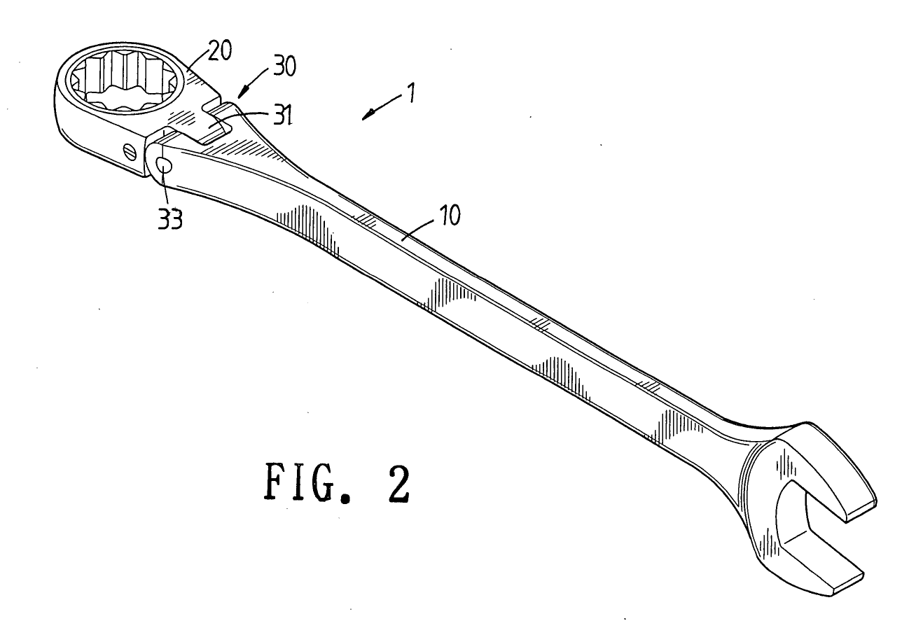

With reference to FIGS. 1 and 2, the structure of the present invention is illustrated.

The spanner 1 of the present invention has a holding portion 10; one engaging portion 20; and a pivotal portion 30 for connecting the holding portion 10 and the engaging portion 20. Thereby, the engaging portion is rotatable respective the holding portion 10.

The engaging portion 20, in this embodiment, is a ratchet spanner portion. The engaging portion 20 serves to engage with and drives a screw element.

The pivotal portion 30 has the following elements.

A connecting block 31 is at one end of the engaging portion 20. The connecting block 31 has a via hole 310.

A connecting groove 32 is at one end of the holding portion 10 for combining with the connecting block 31. Two sides of the connecting groove 32 are formed with through holes 320, respectively.

A shaft 33 is inserted through the through holes 320 of the connecting groove 32 and the via hole 310 of the connecting block 31 so as to fix the connecting block 31 to the connecting groove 32.

A washer 34 is adhered to one side of the via hole 310 of the connecting block 3 1.

Thereby, the engaging portion 20 is rotatable with respect to the holding portion 10.

The holding portion 10 has two bottoms 11 and two lateral surfaces 12. In one operation example, a screw is as a rotating center of the spanner 1. Normal lines of the bottoms are parallel to an axis of the screw. The normal lines of the lateral surfaces are in parallel to the rotating direction of the screw.

The areas of the bottoms are reduced from the connecting groove 32 to a normal area with a predetermined width X. In the normal area, the ratio of the width X of the bottoms to the width Y of the lateral surfaces is between 2/5 to 2/9.

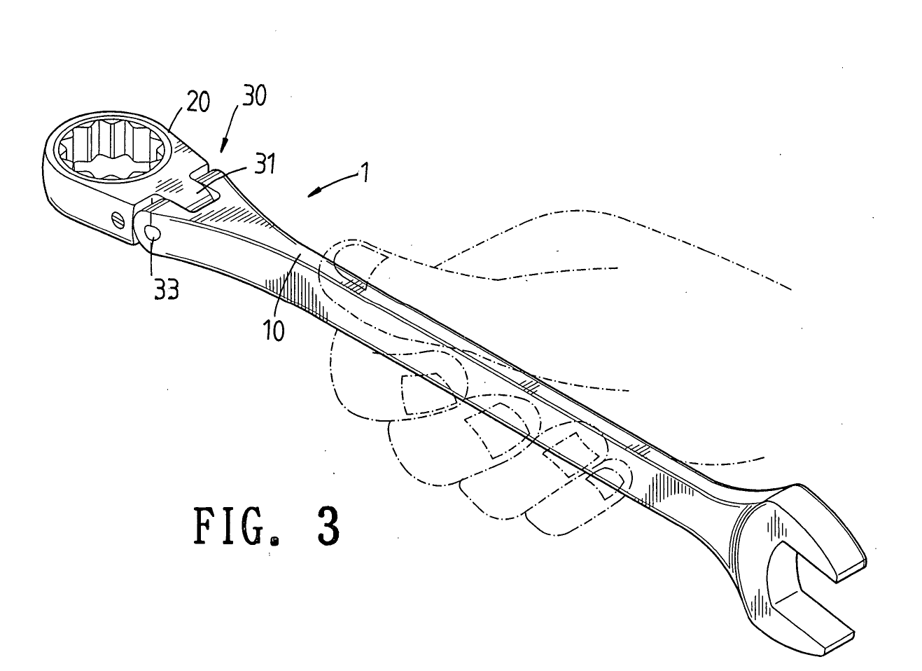

Referring to FIG. 3, it is illustrated that the arrangement of the holding portion 10 causes that the user can hold the spanner 1 comfortably so that the screw can be driven easily and conveniently. Since the lateral surface is larger than the bottom, a great force can be applied to the screw to be driven. Thereby, the hand disease due to long time operation can be prevented. Since in the present invention, the areas of the bottoms are reduced from the connecting groove 32 to a normal area with a predetermined width. The force in screwing can be dispersed to the whole structure so that the spanner 1 has a concrete structure. Thereby, since the holding portion 10 is slender so that the weight thereof can be reduced.

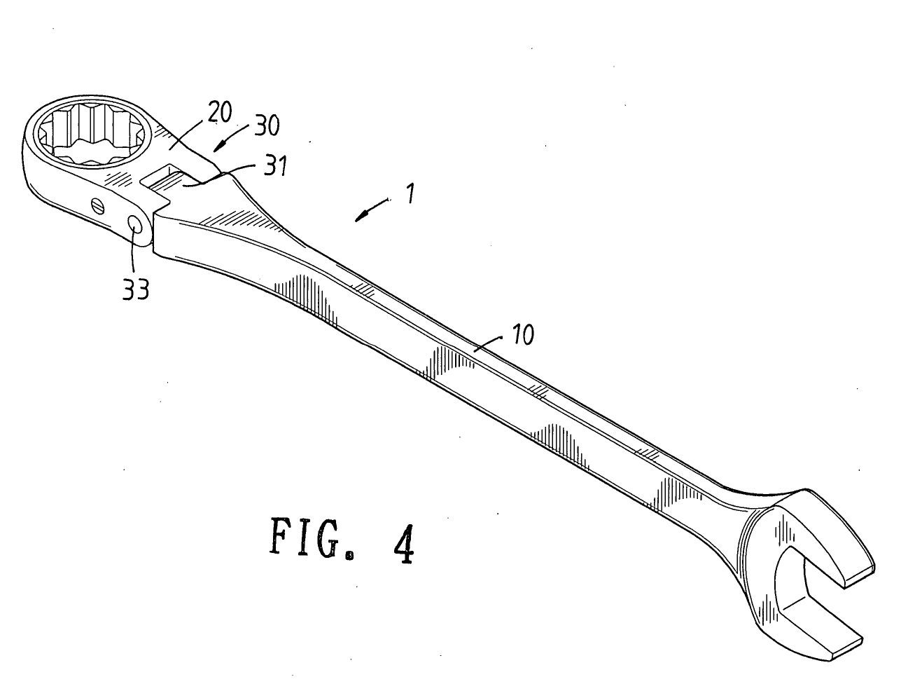

With reference to FIG. 4, the second embodiment of the present invention is illustrated. The main elements identical to the first embodiment will not be further described herein. In the following, the difference of this embodiment from the previous one will be described. In this the present invention, the connecting block 31 of the pivotal portion 30 is formed to the holding portion 10 and the connecting groove 32 is formed on the engaging portion 20

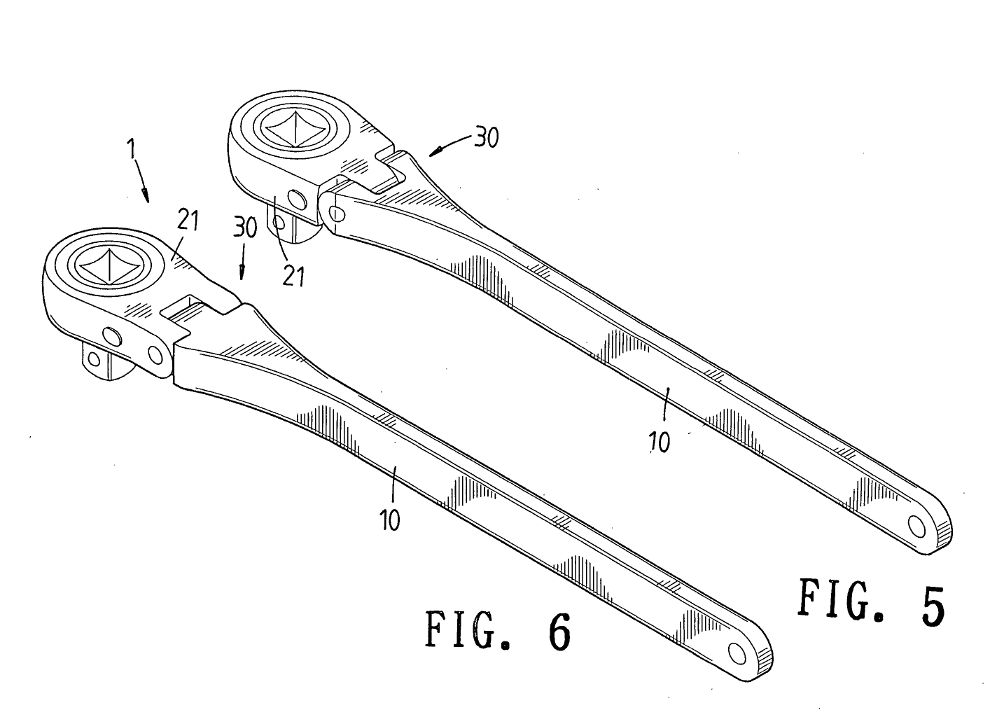

With reference to FIG. 5, the third embodiment of the present invention is illustrated. The main elements identical to the first embodiment will not be further described herein. In the following, the difference of this embodiment from the previous one will be described. In this the present invention, the engaging portion 20 is a D head engaging portion 21 which has a rectangular post protruded from the engaging portion.

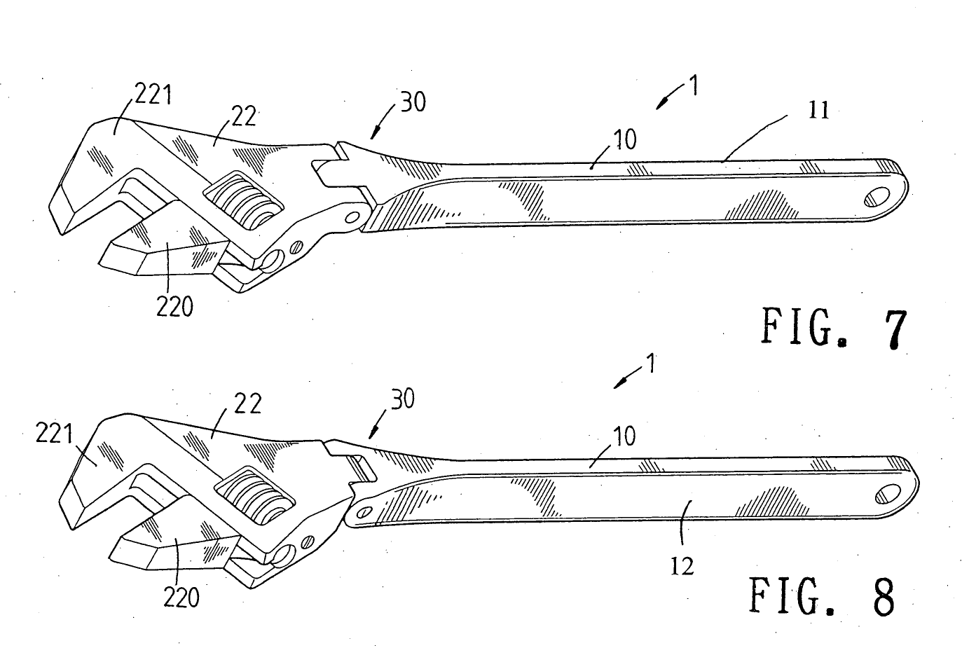

Referring to FIG. 7, the fourth embodiment of embodiment will be described herein. The main elements identical to the first embodiment will not be further described herein. In the following, the difference of this embodiment from the previous one will be described. In this embodiment, the engaging portion 22 is an adjustable engaging portion having a fixing portion 221 and a movable portion 22 so as to adjust the size of an opening between the fixing portion 221 and the movable portion 22 for claiming a screwing element.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A comfortable driving spanner having
a holding portion;
an engaging portion; and
wherein the holding portion has two bottoms and two lateral surfaces; areas of the bottoms are reduced from the connecting groove to a normal area with a predetermined width; in the normal area, the ratio of the width of the bottoms to the width of the lateral surfaces is between 2/5 to 2/9.

2. The comfortable driving spanner as claimed in claim 1, further comprising a pivotal portion for connecting the holding portion and the engaging portion thereby, the engaging portion being rotatable with respect to the holding portion for engaging with and driving a screw element.

3. A comfortable driving spanner having a holding portion; an engaging portion; a pivotal portion for connecting the holding portion and the engaging portion thereby, the engaging portion being rotatable with respect to the holding portion for engaging with and driving a screw element; wherein the pivotal portion comprising:
a connecting block being at one end of the engaging portion; the connecting block having a via hole;
a connecting groove at one end of the holding portion for combining with the connecting block; two sides of the connecting groove being formed with through holes, respectively;
a shaft inserted through the through holes of the connecting groove and the via hole of the connecting block so as to fix the connecting block to the connecting groove;
a washer adhered to one side of the via hole of the connecting block; the engaging portion being rotatable with respect to the holding portion;
wherein the holding portion has two bottoms and two lateral surfaces; areas of the bottoms are reduced from the connecting groove to a normal area with a predetermined width; in the normal area, the ratio of the width of the bottoms to the width of the lateral surfaces is between 2/5 to 2/9.
